(19) United States
(12) Patent Application Publication
(10) Pub. No.: US 2025/0172165 A1
(43) Pub. Date: May 29, 2025

(54) CLIP STRUCTURE

(71) Applicant: PROSCO CO., LTD, Hwaseong-si (KR)

(72) Inventor: Bo Sung HWANG, Hwaseong-si (KR)

(21) Appl. No.: 18/836,334

(22) PCT Filed: Feb. 9, 2023
(86) PCT No.: PCT/KR2023/001913

§ 371 Date: Aug. 6, 2024

(30) Foreign Application Priority Data
Feb. 11, 2022 (KR) 10-2022-0018036

(51) Int. Cl. F16B 5/06; B60R 13/02

(52) U.S. Cl. CPC F16B 5/065; B60R 13/0206

(57) ABSTRACT

Provided is a clip structure. In the clip structure, a pair of catching hooks includes a plurality of clip bodies each having hook grooves formed therein, such that the structure can be simplified, a mounting member and a mounted member can be coupled to each other easily, the coupling force can be increased, and the difficulty of manufacturing a mold for injection molding can be addressed.

### DESCRIPTION

### Technical Field

The present invention relates to a clip structure used to mount a mounting member (for example, a pillar garnish) on a mounted member (for example, a pillar).

### Background Art

A pillar part between a windshield and a front door of a vehicle is referred to as a front pillar, a pillar part between a front door and a rear door is referred to as a center pillar, and a pillar part between a rear door and a rear glass is referred to as a rear pillar.

A pillar garnish is coupled to the pillars. The pillar garnish may add stability and a sense of luxury to a vehicle body in addition to providing a neat exterior and may be classified into a door garnish, a side garnish, a rear garnish, and the like.

Meanwhile, when the pillar garnish, which is a mounting member, is coupled to the pillar, which is a mounted member, the coupling is performed through a clip. The clip causes a separation distance to be present between the pillar and the pillar garnish having a curtain airbag embedded therein and thus allows the pillar garnish to be apart from the pillar. Accordingly, the curtain airbag can deploy in the vehicle through the separation distance, and the pillar garnish can be suppressed from being displaced due to the expansion of the curtain airbag. The clip has been published in Korean Patent Registration No. 10-2021226 (hereinafter, referred to as “pre-registered patent”).

The pre-registered patent provides a clip structure that can be easily attached and detached and firmly fitted, and the clip structure includes a connecting member, a pin (hereinafter, referred to as “first clip part”) configured to be inserted into the connecting member, caught therein, and fixed, and a grommet (hereinafter, referred to as “second clip part”) configured to have the first clip part inserted thereinto, rotate relative to the first clip part, and be caught in the first clip part and fixed.

That is, the connecting member and the second clip part can be connected through the first clip part while the connecting member is caught in any one of a pillar and a pillar garnish and fixed, and the second clip part is caught in any one of the pillar garnish and the pillar and fixed.

However, in the clip structure of the pre-registered patent described above, when the first clip part coupled to the pillar, which is a mounting member, is inserted into the second clip part coupled to the pillar garnish, which is a mounted member, through the connecting member having a detachable structure or the connecting member having an integrated structure, the second clip part rotates forward, and a protrusion portion of the second clip part is caught in a guide groove portion formed in the first clip part and fixed. Simultaneously, a catching concave portion formed in the first clip part is caught in a catching convex portion formed on the second clip part and fixed. There is a problem in that the structure is complex due to coupling between the first and second clip parts constituting the clip structure, which makes it difficult to manufacture a mold for injection molding of the clip structure.

### DISCLOSURE

### Technical Problem

The present invention is directed to providing a clip structure that can simplify the structure and facilitate coupling between a mounting member (for example, a pillar) and a mounted member (for example, a pillar garnish).

### Technical Solution

A clip structure according to the present invention includes a first clip body in which a first catching portion, which is caught in a first fixing portion of a mounting member and fixed by rotating a predetermined angle, is formed; and a second clip body coupled to the first clip body and in which a second catching portion, which is caught in a second fixing portion of a mounted member and fixed, is formed, wherein the first clip body is a pin-type structure on which a first flange configured to come in contact with the first fixing portion is formed and has a pair of catching hooks formed thereon, the second clip body is a tubular structure on which a second flange configured to come in contact with the second fixing portion is formed and in which a hollow portion is formed and has a pair of hook grooves in which the catching hooks are caught formed therein, the second catching portion has a handle frame, which is configured to come in contact with one surface of the mounted member, and a hook frame, which has an inclined surface and a vertical surface configured to come in contact with the other surface of the mounted member, formed to be spaced apart on cut frames each formed on one surface and the other surface of the second clip body and cut in a right-angled c-shape to be movable, a second seating groove on which the mounted member is seated is formed between the handle frame and the hook frame spaced apart from each other, and separation guide grooves configured to provide a movement space of the cut frames for separation of the second clip body seated on the second seating groove are each formed on one surface and the other surface of the first clip body.

Also, the first fixing portion is a frame structure formed to protrude from one surface of the mounting member and has a first catching hole and a catching protrusion formed to protrude adjacent to the first catching hole, and the first catching portion is a rectangular or elliptical block structure formed to protrude from the other surface of the first flange so that a first seating groove on which the mounting member is seated is formed.

Also, as the first catching hole is formed with a rectangular or elliptical hole structure to correspond to the first catching portion which is the rectangular or elliptical block structure, the first catching portion is caught in the first fixing portion when rotated at a predetermined angle after passing from one surface toward the other surface of the first catching hole.

Also, a U-shaped catching groove in which the catching protrusion is caught when the first catching portion is rotated at the predetermined angle is formed in the first flange.

Also, a guide protrusion having the shape of an arrow that guides passing through the hollow portion formed in the second clip body is formed on the other end of the first clip body, and the guide protrusion comes in contact with an end surface in the hollow portion to enable separation of the first clip body from the second clip body.

In addition, the second fixing portion is a frame structure formed on one surface of the mounted member and has a second catching hole formed therein, the second clip body includes a first body formed at one side of the mounted member with respect to the second flange and having the hook groove formed therein for coupling to the first clip body; and a second body formed at the other side of the mounted member and having the second fixing portion formed thereon for coupling to the mounted member, and the hollow portion is formed to pass through the first and second bodies.

### Advantageous Effects

According to the present invention, by constituting a clip structure that achieves structural simplification, an effect of facilitating coupling between a mounting member and a mounted member as well as an effect of increasing a coupling force thereof can be expected.

The advantageous effects of the present invention are not limited to those mentioned above, and other unmentioned advantageous effects should be clearly understood by those of ordinary skill in the art from the claims below.

### DESCRIPTION OF DRAWINGS

FIG. 1 is a coupling perspective view of a clip structure according to one embodiment of the present invention.

FIG. 2 is an exploded perspective view of the clip structure according to one embodiment of the present invention.

FIG. 3 is a cross-sectional view along line A-A of FIG. 1 according to one embodiment of the present invention.

FIG. 4 is a cross-sectional view along line B-B of FIG. 1 according to one embodiment of the present invention.

FIG. 5 is a perspective view showing a state in which a mounting member and a mounted member are connected and coupled using a clip structure according to one embodiment of the present invention.

FIG. 6 is an exploded perspective view of the clip structure, the mounting member, and the mounted member according to one embodiment of the present invention.

FIGS. 7A, 7B, and 7C are schematic cross-sectional views showing an order of separating the clip structure coupled to the mounting member from the mounted member according to one embodiment of the present invention.

### BEST MODE OF THE INVENTION

Advantages and features of the present invention and methods of achieving the same should become clear from embodiments described in detail below with reference to the accompanying drawings. However, embodiments according to the technical spirit of the present invention are not limited to the embodiments disclosed below and may be implemented in various different forms. The present embodiments are only provided to make the disclosure of the present invention complete and completely inform those of ordinary skill in the art to which the present invention pertains of the scope of the invention. The scope of the embodiments according to the technical spirit of the present invention is only defined by the scope of the claims.

Terms used in the present specification are for describing the embodiments and are not intended to limit the present invention. In the present specification, a singular expression includes a plural expression unless the context clearly indicates otherwise.

In the present specification, terms such as “include” or “have” are intended to designate the presence of features, numbers, steps, operations, components, parts, or combinations thereof mentioned herein and should not be understood as precluding the possibility of presence or addition of one or more other features, numbers, steps, operations, components, parts, or combinations thereof.

Also, the embodiments described herein will be described with reference to cross-sectional views and/or plan views which are ideal exemplary views of the present invention. Therefore, instead of being limited to specific illustrated forms, the embodiments of the present invention also include necessary changes in shapes. For example, an area illustrated as right-angled may be round or have a shape having a predetermined curvature. Therefore, areas illustrated in the drawings have schematic attributes, and the shapes of the areas illustrated in the drawings are for illustrating specific shapes of areas of a device and are not intended to limit the scope of the invention.

Throughout the specification, the same reference numerals refer to the same components. Therefore, the same reference numerals or similar reference numerals may be described with reference to other drawings even when not mentioned or described in the corresponding drawings. Also, reference numerals may be described with reference to other drawings even when not marked therein.

Hereinafter, embodiments of the present invention will be described with reference to the accompanying drawings.

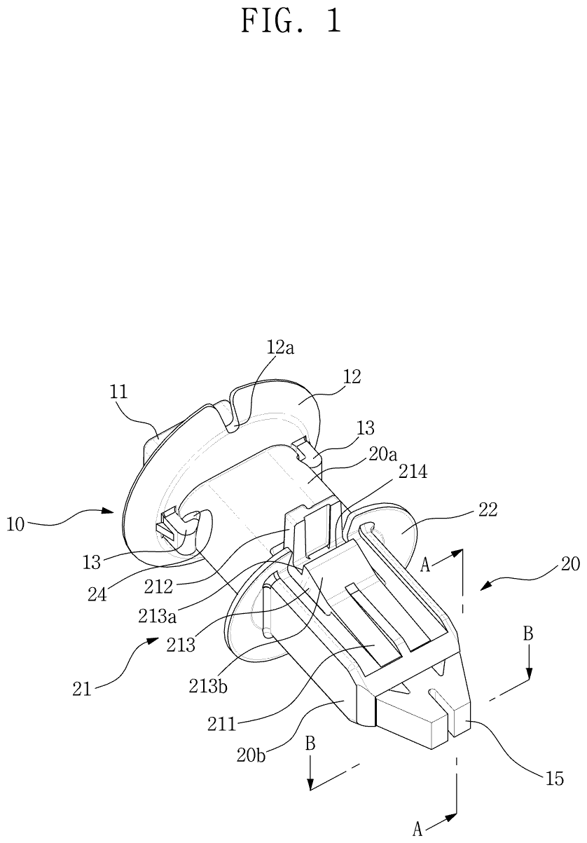

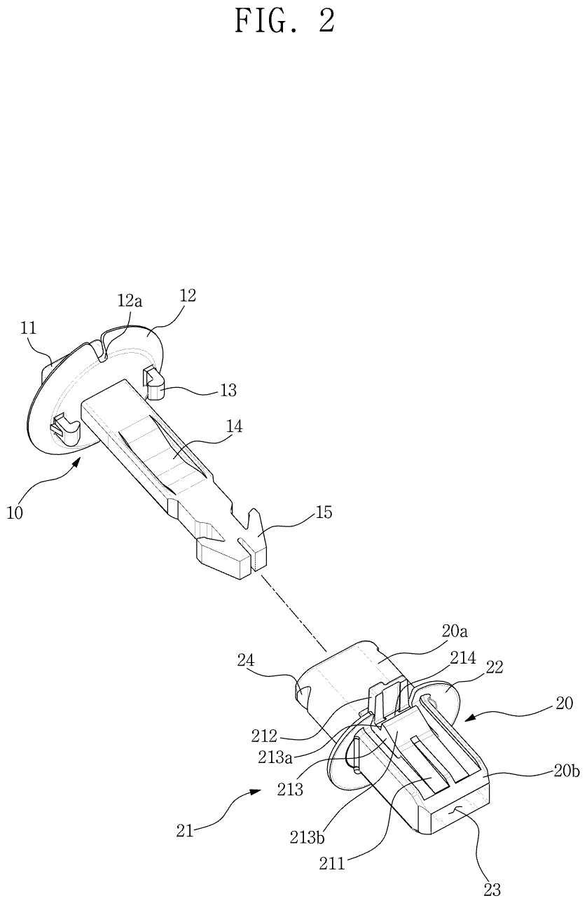

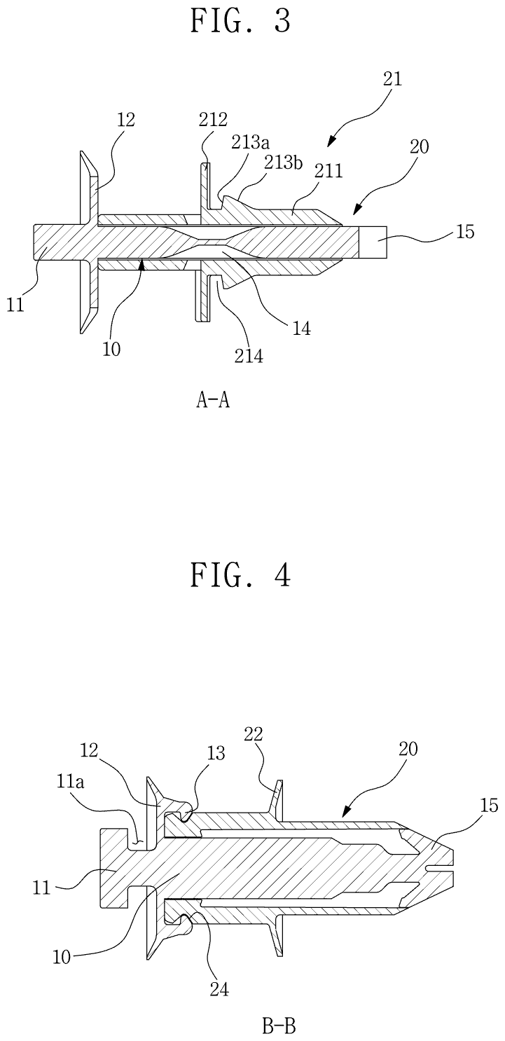

FIG. 1 is a coupling perspective view of a clip structure according to one embodiment of the present invention, FIG. 2 is an exploded perspective view of the clip structure according to one embodiment of the present invention, FIG. 3 is a cross-sectional view along line A-A of FIG. 1 according to one embodiment of the present invention, and FIG. 4 is a cross-sectional view along line B-B of FIG. 1 according to one embodiment of the present invention.

Referring to FIGS. 1 to 4, a clip structure according to one embodiment of the present invention includes a first clip body 10 and a second clip body 20.

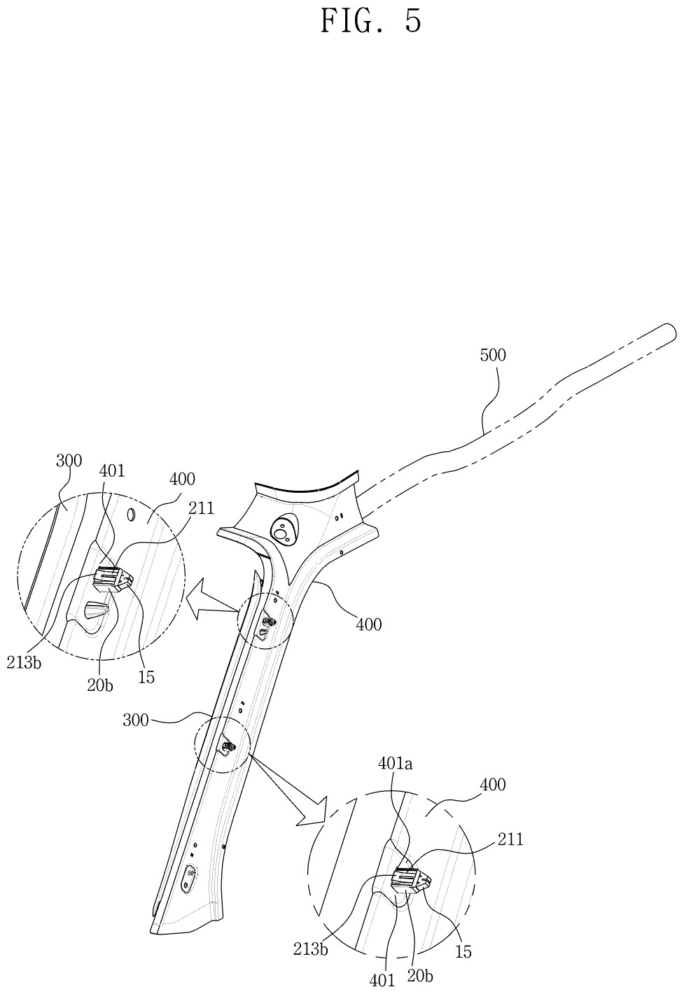

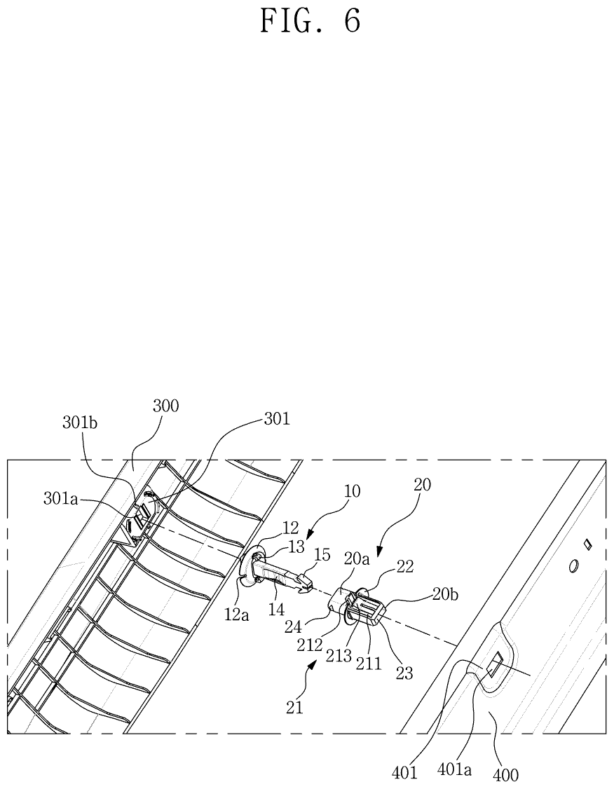

As illustrated in FIGS. 5 to 7, the first clip body 10 may be configured as a pin-type structure in which a first catching portion 11, which is caught in a first fixing portion 301 of a mounting member 300 (for example, a pillar garnish) and fixed by rotating a predetermined angle (for example, 90°), is formed. In the pin-type structure, a first flange 12 configured to come in contact with the first fixing portion 301, and a pair of catching hooks 13, a separation guide groove 14, and a guide protrusion 15 may be formed.

The first fixing portion 301 is a frame structure formed to protrude from one surface of the mounting member 300, and a first catching hole 301a and a catching protrusion 301b protruding adjacent to the first catching hole 301a may be formed in the frame structure.

The first catching portion 11 may be a rectangular or elliptical block structure formed to protrude from the other surface of the first flange 12 so that a first seating groove 11a on which the mounting member 300 is seated is formed. Accordingly, the first catching hole 301a may be formed with a rectangular or elliptical hole structure to correspond to the first catching portion 11 which is the rectangular or elliptical block structure. The first catching portion 11 may be caught in the first fixing portion 301 when rotated at a predetermined angle (for example, 90°) after passing from one surface toward the other surface of the first catching hole 301a.

A U-shaped catching groove 12a may be formed in the first flange 12, and the catching protrusion 301b may be caught in the catching groove 12a when the first catching portion 11 is rotated at the predetermined angle.

That is, after the first catching portion 11 passes the first fixing portion 301, the first flange 12 constituting the first clip body 10 may be rotated a predetermined angle (for example, 90°). Then, the first catching portion 11 may be caught at the other surface of the first fixing portion 301. Here, as the catching protrusion 301b is fitted to the catching groove 12a formed in the first flange 12, the first flange 12 can be prevented from rotating.

The separation guide groove 14 is formed in each of one surface and the other surface of the first clip body 10 and provides a movement space of cut frames 211, which will be described below, for separation of the second clip body 20 seated on a second seating groove 214, which will be described below.

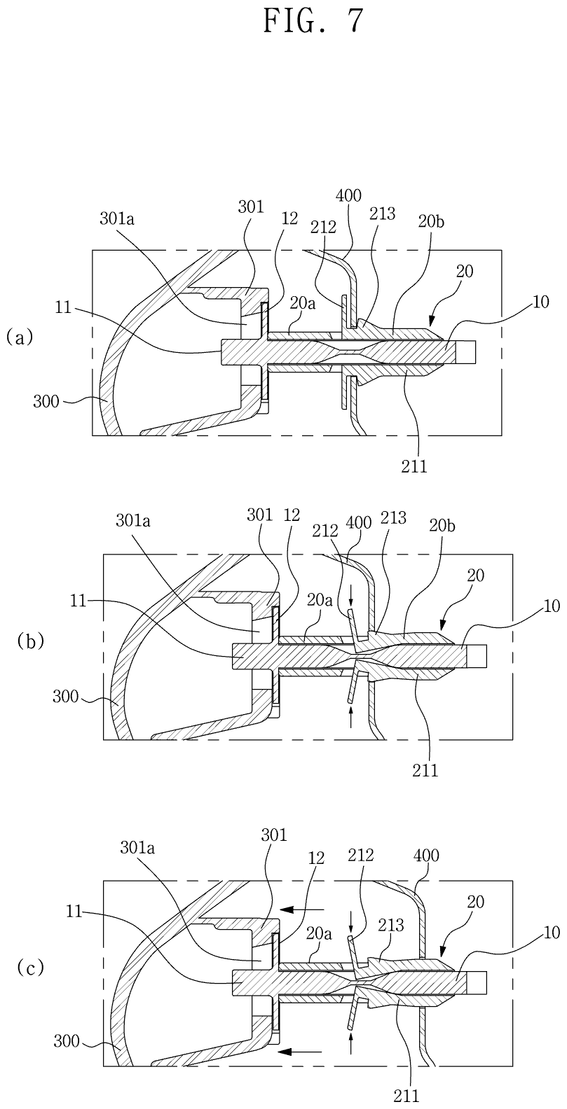

That is, in a state in which the second clip body 20, which is either coupled to the first clip body 10 or separated from the first clip body 10, is coupled to a mounted member 400, the second clip body 20 may be separated from the mounted member 400 as illustrated in FIG. 7. Then, the separation guide grooves 14 provide a movement space of the cut frames 211 pressed for the separation of the second clip body 20.

The guide protrusion 15 may be an arrow-shaped structure formed at the other end of the first clip body 10. The guide protrusion 15 guides passing through a hollow portion 23, which will be described below, formed in the second clip body 20, and the guide protrusion 15 may come in contact with an end surface in the hollow portion 23 to enable separation of the first clip body 10 from the second clip body 20.

That is, when the guide protrusion 15 passes through the hollow portion 23, deviates from the hollow portion 23, and reaches a caught state, it becomes impossible to separate the first clip body 10 from the second clip body 20. Thus, the guide protrusion 15 comes in contact with an end surface in the hollow portion 23 without being caught and fixed.

The second clip body 20 is fastened to the first clip body 10 and may be, as illustrated in FIGS. 5 to 7, a tubular structure in which a second catching portion 21, which is configured to be caught in a second fixing portion 401 of the mounted member 400 (for example, a pillar) and fixed, is formed. Therefore, a second flange 22 coming in contact with the second fixing portion 401, the hollow portion 23 through which the first clip body 10 passes, and a pair of hook grooves 24 in which the catching hooks 13 are caught may be formed.

The second catching portion 21 may have a handle frame 212, which is configured to come in contact with one surface of the mounted member 400, and a hook frame 213, which has an inclined surface 213b and a vertical surface 213a configured to come in contact with the other surface of the mounted member 400, formed to be spaced apart on the cut frames 211 each formed on one surface and the other surface of the second clip body 20 and cut in a right-angled c-shape to be movable. The second seating groove 214 on which the mounted member 400 is seated may be formed between the handle frame 212 and the hook frame 213 spaced apart from each other.

The second fixing portion 401 is a frame structure formed on one surface of the mounted member 400 and may have a second catching hole 401a formed therein. The second clip body 20 may be divided into a first body 20a formed at one side of the mounted member 400 with respect to the second flange 22 and having the hook groove 24 formed therein for coupling to the first clip body 10, and a second body 20b formed at the other side of the mounted member 400 and having the second fixing portion 401 formed thereon for coupling to the mounted member 400. The hollow portion 23 may be formed to pass through the first and second bodies 20a and 20b.

### MODES OF THE INVENTION

The clip structure according to embodiments of the present invention will be described in more detail with reference to FIGS. 1 to 7.

First, the first clip body 10, which is a pin-type structure, is inserted into the hollow portion 23 of the second clip body 20, which is a tubular structure, to bring the guide protrusion 15 formed on the first clip body 10 into contact with the end surface in the hollow portion 23 without the guide protrusion 15 being caught thereat.

Then, as the catching hook 13 formed to protrude from the first flange 12 included in the first clip body 10 is caught in the hook groove 24 formed in the first body 20a constituting the second clip body 20 and fixed, coupling between the first and second clip bodies 10 and 20 is completed.

Next, the first catching portion 11 which is a block structure formed on the first clip body 10 is caught at the first fixing portion 301 formed on the mounting member 300 and fixed. That is, the first catching portion 11 is caused to pass through the first catching hole 301a included in the first fixing portion 301 while rotating the first clip body 10 at a predetermined angle (for example, 90°), and then the first clip body 10 is rotated at a predetermined angle (for example, −90°) to its original position.

Then, the mounting member 300 may be seated on the first seating groove 11a formed adjacent to the first catching portion 11. Therefore, as the first catching portion 11 is caught at the other surface of the first fixing portion 301, and simultaneously, the catching protrusion 301b formed on the first fixing portion 301 is fitted to the catching groove 12a formed in the first flange 12 included in the first clip body 10, the first clip body 10 can be mounted on the mounting member 300 and fixed, and rotation of the first clip body 10 can be prevented.

Although it has been described above that the second clip body 20 is coupled to the first clip body 10, and then the first clip body 10 is coupled to the mounting member 300, the first clip body 10 may be coupled to the mounting member 300, and then the second clip body 20 may be coupled to the first clip body 10.

Next, since the mounting member 300 should be mounted on the mounted member 400, and thus, the second clip body 20 is first coupled to the first clip body 10 coupled to the mounting member 300, the second clip body 20 is caught at the second fixing portion 401, which is formed on the mounted member 400, and fixed.

That is, since the second fixing portion 401 is a frame structure and has the second catching hole 401a formed therein, while bringing the mounting member 300 closer to the mounted member 400, the second clip body 20 is inserted into the second catching hole 401a.

Then, as the hook frame 213 formed to protrude from the second body 20b of the second clip body 20 is able to pass through the second catching hole 401a through the inclined surface 213b, the vertical surface 213a formed on the hook frame 213 may come in contact with the other surface of the mounted member 400 and be caught thereat, and the handle frame 212 may come in contact with one surface of the mounted member 400 and be caught thereat.

That is, the second catching portion 21 includes the cut frames 211 each formed on one surface and the other surface of the second clip body 20 and cut in a right-angled c-shape to be movable, and the handle frame 212 and the hook frame 213 are formed on the cut frames 211. Therefore, when the second body 20b of the second clip body 20 passes through the second catching hole 401a, the inclined surface 213b of the hook frame 213 comes in contact with the mounted member 400, and according to the contact, the cut frames 211 are able to move toward the separation guide grooves 14 formed in the first clip body 10. Accordingly, the hook frame 213 may pass through the second catching hole 401a.

When the hook frame 213 passes through the second catching hole 401a as described above, the mounted member 400 may be seated on the second seating groove 214 formed between the handle frame 212 and the hook frame 213. Then, as the handle frame 212 and the hook frame 213 are caught at one surface and the other surface of the mounted member 400, respectively, and the second clip body 20 is coupled to the mounted member 400, mounting and fixing of the mounting member 300 on and to the mounted member 400 is completed.

Therefore, since the mounting member 300 is mounted on the mounted member 400 and fixed, even when a curtain airbag 500 installed in the mounting member 300 expands due to a predetermined impact, the mounting member 300 is not completely separated from the mounted member 400 because the second clip body 20 coupled to the mounted member 400 and the first clip body 10 coupled to the second clip body 20 are caught at the mounting member 300 and fixed by the first fixing portion 301 which is a block structure.

Meanwhile, when the curtain airbag 500 expands and deploys as described above, or it is necessary to separate the mounting member 300 from the mounted member 400, first, the mounting member 300 is rotated 90° leftward or rightward.

Then, the first catching portion 11 of the first clip body 10 can be released from the first catching hole 301a of the first fixing portion 301 formed on the mounting member 300.

That is, the first catching hole 301a and the first catching portion 11 may each form a rectangular or elliptical structure, and the first catching portion 11 may remain caught while orthogonal to the first catching hole 301a. Accordingly, when the mounting member 300 is rotated 90° leftward or rightward, the first catching portion 11, which becomes orthogonal, may have the same direction as the first catching hole 301a. Then, the first catching hole 301a can be detached from the first catching portion 11, and thus the mounting member 300 having the first fixing portion 301 can be separated from the first clip body 10.

Then, the handle frame 212 included in the second fixing portion 401 formed on the second body 20b of the second clip body 20 coupled to the first clip body 10 is pressed toward the first clip body 10 as illustrated in FIG. 7B.

Then, as the cut frame 211 on which the handle frame 212 is formed moves to the separation guide groove 14 formed in the first clip body 10, the hook frame 213 formed on the cut frame 211 also moves toward the separation guide groove 14, and contact of the vertical surface 213a of the hook frame 213 with the other surface of the mounted member 400 can be released.

Here, when the first clip body 10 coupled to the second clip body 20 is pulled in a direction opposite to the mounted member 400, the second clip body 20 may be separated from the mounted member 400.

Meanwhile, although the process of separating the mounting member 300 from the first clip body 10 first and then separating the second clip body 20 coupled to the first clip body 10 from the mounted member 400 has been described above, the mounting member 300 may be slightly pulled so that a worker's finger can enter between the mounting member 300 and the mounted member 400, the second clip body 20 may be separated from the mounted member 400 first, and then the first clip body 10 may be separated from the mounting member 300 to separate the mounting member 300 from the mounted member 400.

The technical spirit of the clip structure of the present invention has been described above with reference to the accompanying drawings, but the embodiments described herein are only some examples of the embodiments of the present invention and are not intended to limit the present invention.

Therefore, the present invention is not limited to the specific embodiments described above, those of ordinary skill in the art to which the invention pertains may make various modifications without departing from the gist of the present invention claimed in the claims, and such modifications also fall within the scope of the claims.

### INDUSTRIAL APPLICABILITY

By a clip structure of the present invention, the structure can be simplified, coupling between a mounting member and a mounted member can be facilitated, a coupling force thereof can be increased, and difficulty in manufacturing a mold for injection molding can be addressed.

1. A clip structure comprising:
a first clip body in which a first catching portion, which is caught in a first fixing portion of a mounting member and fixed by rotating a predetermined angle, is formed; and
a second clip body coupled to the first clip body and in which a second catching portion, which is caught in a second fixing portion of a mounted member and fixed, is formed,
wherein the first clip body is a pin-type structure on which a first flange configured to come in contact with the first fixing portion is formed and has a pair of catching hooks formed thereon, the second clip body is a tubular structure on which a second flange configured to come in contact with the second fixing portion is formed and in which a hollow portion is formed and has a pair of hook grooves in which the catching hooks are caught formed therein,
the second catching portion has a handle frame, which is configured to come in contact with one surface of the mounted member, and a hook frame, which has an inclined surface and a vertical surface configured to come in contact with the other surface of the mounted member, formed to be spaced apart on cut frames each formed on one surface and the other surface of the second clip body and cut in a right-angled c-shape to be movable, and a second seating groove on which the mounted member is seated is formed between the handle frame and the hook frame spaced apart from each other, and
separation guide grooves configured to provide a movement space of the cut frames for separation of the second clip body seated on the second seating groove are each formed on one surface and the other surface of the first clip body.

2. The clip structure of claim 1, wherein:
the first fixing portion is a frame structure formed to protrude from one surface of the mounting member and has a first catching hole and a catching protrusion formed to protrude adjacent to the first catching hole; and
the first catching portion is a rectangular or elliptical block structure formed to protrude from the other surface of the first flange so that a first seating groove on which the mounting member is seated is formed.

3. The clip structure of claim 2, wherein, as the first catching hole is formed with a rectangular or elliptical hole structure to correspond to the first catching portion which is the rectangular or elliptical block structure, the first catching portion is caught in the first fixing portion when rotated at a predetermined angle after passing from one surface toward the other surface of the first catching hole.

4. The clip structure of claim 2, wherein a U-shaped catching groove in which the catching protrusion is caught when the first catching portion is rotated at the predetermined angle is formed in the first flange.

5. The clip structure of claim 1, wherein a guide protrusion having the shape of an arrow that guides passing through the hollow portion formed in the second clip body is formed on the other end of the first clip body, and the guide protrusion comes in contact with an end surface in the hollow portion to enable separation of the first clip body from the second clip body.

6. The clip structure of claim 1, wherein:
the second fixing portion is a frame structure formed on one surface of the mounted member and has a second catching hole formed therein;
the second clip body includes a first body formed at one side of the mounted member with respect to the second flange and having the hook groove formed therein for coupling to the first clip body; and a second body formed at the other side of the mounted member and having the second fixing portion formed thereon for coupling to the mounted member; and
the hollow portion is formed to pass through the first and second bodies.
